(19) United States
(12) Patent Application Publication
(10) Pub. No.: US 2021/0113910 A1
(43) Pub. Date: Apr. 22, 2021

(54) Simone Says

(71) Applicant: Stephanie Ann Green, Milwaukie, OR (US)

(72) Inventor: Stephanie Ann Green, Milwaukie, OR (US)

(21) Appl. No.: 16/655,900

(22) Filed: Oct. 17, 2019

(51) Int. Cl. A63B 71/06; A63B 71/02

(52) U.S. Cl. CPC A63B 71/0622; A63B 2071/0625; A63B 2208/12; A63B 71/023

(57) ABSTRACT

The purpose of this patent application is to obtain a patent on the Simone Says. The main purpose for this invention is to benefit kids to get them engaged and involved in kids outdoor games, activities, music and nursery rhymes through the use of a game console or panel that is secured to a stand and that can be mounted in the grass or on any flattish surface.

### CROSS-REFERENCE TO RELATED APPLICATIONS

This section is non-applicable to this patent application.

### STATEMENT REGARDING FEDERALLY SPONSORED RESEARCH OR DEVELOPMENT (IF APPLICABLE)

There are no rights to this invention under federally sponsored research and development programs.

### REFERENCE TO SEQUENCE LISTING, A TABLE, OR A COMPUTER PROGRAM LISTING COMPACT DISC APPENDIX

This section is non-applicable to this patent application.

### BACKGROUND OF THE INVENTION

This invention is a new invention in which no patents or ideas already exist. This is a brand new product that will be brought to the market. This invention does not improve any other product on the market. It is a new product and that is standalone. The main impetus for the Simone Says is to provide kids with a cool interactive game console, that plays games so kids can learn new games and be entertained while engaging in exercise. This is an interactive game console that is affixed to a stand and can be mounted in the grass or free stand on the pavement or floor. The game console has several buttons that the kids push and when they push the button a game starts to play. Games are varied but are similar to; Simon Says, Red Rover Red Rover, Red-light/Green-light and Freeze Tag to name a few. The game console will also play music and nursery rhymes. The game console and the stand is roughly 3 feet high so kids can stick the base into the grass or place on the pavement and push a button to start a game. The game starts and the kids play along with the game. There is also a red light and green light on the console that is used for kids to time themselves when running or doing obstacles or other activities. There is also a timer on the game that can time how fast kids run or do similar activities. The game console runs on batteries and there is an on and off switch to start and stop the game.

Stephanie Ann Green is a full-time working mother of 3 small kids with an MBA. Her house is comprised of 3 small children that she is always looking to get out of the house and exercise with them. As a busy working mother, she doesn't always have time to spend every minute with her kids doing physical activity. She also realized that her kids were not privy to some of the fun outdoor kids' games that she played as a child. The combined need of physical activity for her kids and the desire to have them be more cultured with kids' games, led her to create the Simone Says.

### BRIEF SUMMARY OF THE INVENTION

As mentioned above, there is a huge market and need for this product. The invention solves the problem of providing kids with more physical activity, while educating them on kids' games while also engaging and entertaining them. The Simone says is a game console that includes kids' games, timers, red light, green light, and nursery rhymes to name a few. The game console can mount in the grass or flat surfaces. The child turns on the button and presses the desired button for the game he/she wishes to play and then starts to play the game. When done, the child turns off the game.

### BRIEF DESCRIPTION OF THE SEVERAL VIEWS OF THE DRAWING

Please refer to separate diagram of the Simone Says. Each element is properly labeled.

### DETAILED DESCRIPTION OF THE INVENTION

There is no other invention like this on the market. This is not an improved product patent either. The process is simple with existing materials on the market. All materials are on the market currently so it's a matter of assembling existing materials that are commercially available. This invention requires the use of a cool or attractively designed game console that is made of plastic and electronics and is programmed with kids' games, nursery rhymes and music. The interface is fairly simple and comprised of buttons and labels. There is a stand that is connected to the game console which mounts it in the grass or onto a flat service to stand by itself. There is a base that holds the game and stand when the user wants to use it on a flat surface. If the user wants to use the Simone Says on the grass, he/she takes it out of the base and sticks it into the grass.

### DRAWINGS

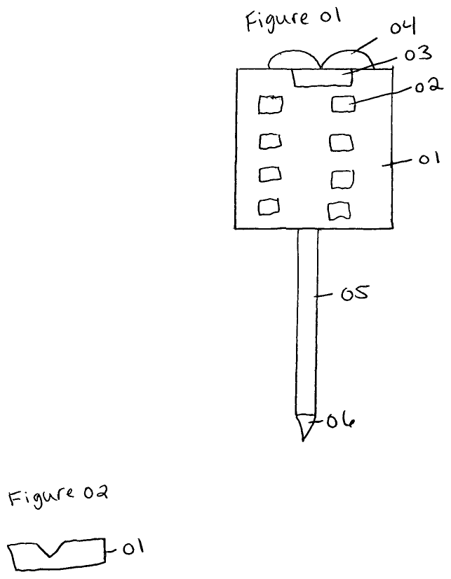

FIG. 01.

Each item that is included in the drawing is labeled as follows:

01=The main part of the Simone Says is the main interactive game console that includes programmed games, activities, nursery rhymes, music or educational games as well. No scope limitations to the actual games or activities that are stored on the game console.

02=These are the buttons that kids push in order to play games.

03=This is a timer so kids can time themselves playing sports.

04=This is a red light and green light that also helps time children when playing sports. It also tells them when to stop and when to go.

05=The stand that the game console is affixed to and the stand has the capability to be mounted directly into the grass via the design at the end of the stand, or it can be mounted into a base that can free stand onto any flattish surface.

06=The part of the Simone Says that mounts into the grass almost like a stake.

FIG. 02.

01=The base of the Simone Says that the stand can be inserted into that allows it to sit flat on any flattish surface.

1) A kid's game console that plays kids' games, activities, nursery rhymes and music and can be mounted into the grass or can free stand on any flat surface.
(a) A kid's game console that is mounted to a stand that can be mounted into the grass or on any flat surface.
(b) A kid's game console that play kids' outdoor games to get kids physically active and that also includes activities, nursery rhymes and music.
(c) A kid's game console that is mounted to a stand for grass usage or flat surface usage, and that kids can push a button to play an outdoor game, activity, music or nursery rhyme.
